(19) United States
(12) Patent Application Publication
(10) Pub. No.: US 2008/0096636 A1
(43) Pub. Date: Apr. 24, 2008

(54) GAMING SYSTEM AND METHOD

(76) Inventor: Kieran Power, Alexandria (AU)

Correspondence Address: MCANDREWS HELD & MALLOY, LTD, 500 WEST MADISON STREET, SUITE 3400, CHICAGO, IL, 60661, US

(21) Appl. No.: 11/779,168

(22) Filed: Jul. 17, 2007

(30) Foreign Application Priority Data
Oct. 20, 2006 (AU) 2006230747

(51) Int. Cl. A63F 13/00

(52) U.S. Cl. 463/20

(57) ABSTRACT

Certain embodiments of the present invention provide a method of displaying an outcome of a game to a player comprising obtaining a stop position for each of a plurality of reels, each reel having a plurality of symbols, each stop position specifying which symbol or symbols of each reel will correspond to a win line, displaying spinning of each reel to the reel's stop position with at least the first reel being spun normally to the first reel's stop position, making the display of the spinning of at least one subsequent reel different to the normal spinning if it is determined that at least one first suspense condition is met, and making the display of at least one later reel different to at least one intervening reel displayed as spun to a stop after the first reel, if at least one second suspense condition is met.

### RELATED APPLICATIONS

This application claims priority to an Australian patent application filed on Oct. 20, 2006, as serial number AU2006230747, entitled “Gaming System and Method.” The foregoing application is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system, a gaming method and a game controller.

Australian patent 603193 discloses a poker machine having a means to cause each reel to turn to a stop in a position where a single line of symbols (one for each reel) is exhibited behind a viewing window. The poker machine has means for determining the length of time for which each reel is spun. If the same symbol is exhibited by a plurality of first stopped reels, normal operation of the machine is suspended and the time for which the next reel is spun is extended. Accordingly, in Australian patent 603193, spinning of a reel is extended in very limited circumstances.

### BRIEF SUMMARY OF THE INVENTION

Certain embodiments of the present invention provide a method of displaying an outcome of a game to a player comprising:
obtaining a stop position for each of a plurality of reels, each reel having a plurality of symbols, each stop position specifying which symbol or symbols of each reel will correspond to a win line;
displaying spinning of each reel to the reel's stop position with at least the first reel being spun normally to the first reel's stop position;
making the display of the spinning of at least one subsequent reel different to the normal spinning if it is determined that at least one first suspense condition is met; and
making the display of at least one later reel different to at least one intervening reel displayed as spun to a stop after the first reel, if at least one second suspense condition is met.

In an embodiment, each at least one intervening reel is a subsequent reel, and making the display of the at least one later reel different comprises making the duration of each later reel different to the normal duration of spinning and the duration of the subsequent reel such that there are three different durations.

In an embodiment, each at least one intervening reel is a reel displayed as spun to a stop after each at least one subsequent reel.

In an embodiment, each at least one later reel is spun for the same duration as each at least one subsequent reel.

In an embodiment, the normal duration comprises a normal range of durations.

In an embodiment, determining whether a suspense condition is met comprises determining whether at least one game outcome that satisfies a suspense condition will appear possible prior to a reel being displayed spinning to the reel's stop position.

In an embodiment, making the duration of the at least one subsequent reel different comprises making the duration longer than the normal duration.

In an embodiment, making the display of the later reel different comprises making the speed of spinning different.

In an embodiment, the method further comprises making the speed of the at least one subsequent reel different to the first reel.

Certain embodiments of the present invention provide a gaming system comprising:
a stop determiner configured to determine a stop position of a each of a plurality of reels, each reel having a plurality of symbols, each stop position specifying which symbol or symbols of the reel will correspond to a win line;
a display for displaying spinning of each reel to the reel's stop position with at least a first reel being spun normally to the first reel's stop position; and
a suspense mode controller configured to determine whether one or more suspense conditions are met and make display of the spinning of at least one subsequent reel different to the normal spinning if it is determined that a first suspense condition is met, and make the display of at least one later reel different to at least one intervening reel displayed as spun to a stop after the first reel if a suspense condition is met.

In an embodiment, each at least one intervening reel is a subsequent reel, and the game controller is configured to make the display of the at least one later reel different by making the duration of each later reel different to the normal duration of spinning and the duration of the subsequent reel such that there are three different durations.

In an embodiment, each at least one intervening reel is a reel displayed as spun to a stop after each at least one subsequent reel.

In an embodiment, each at least one later reel is spun for the same duration as each at least one subsequent reel.

In an embodiment, the normal duration comprises a normal range of durations.

In an embodiment, the game controller determines whether a suspense condition is met comprises determining whether at least one game outcome that satisfies a suspense condition will appear possible prior to a reel being displayed spinning to the reel's stop position.

In an embodiment, display of the at least one subsequent reel is made different by making the duration longer than a normal duration.

In an embodiment, display of the later reel is made different by making the speed of spinning different.

In an embodiment, display of the subsequent reel is made different by making the speed of the at least one subsequent reel different to the first reel.

Certain embodiments of the present invention provide a suspense mode controller for a gaming system, the suspense mode controller configured to:
obtain a stop position of a each of a plurality of reels, each reel having a plurality of symbols, each stop position specifying which symbols of the reel will correspond to respective ones of a plurality of win lines,
determine whether a suspense condition is met in respect of at least one win line played by the player;
make the display of the spinning of at least one subsequent reel different to the normal spinning if it is determined that at least one first suspense condition is met; and
make the display of at least one later reel different to at least one intervening reel displayed as spun to a stop after the first reel, if at least one second suspense condition is met.

In an embodiment, each at least one intervening reel is a subsequent reel, and the suspense mode controller is configured to make the display of the at least one later reel different by making the duration of each later reel different to the normal duration of spinning and the duration of the subsequent reel such that there are three different durations.

In an embodiment, each at least one intervening reel is a reel displayed as spun to a stop after each at least one subsequent reel.

In an embodiment, at least one later reel is spun for the same duration as each at least one subsequent reel.

In an embodiment, the normal duration comprises a normal range of durations.

In an embodiment, the suspense mode controller determines whether a suspense condition is met by determining whether at least one game outcome that satisfies a suspense condition will appear possible prior to a reel being displayed spinning to the reel's stop position.

In an embodiment, the suspense mode controller is configured to make the duration of the at least one subsequent reel different by making the duration longer than the normal duration.

In an embodiment, the suspense mode controller is configured to make the display of the later reel different by making the speed of spinning different.

In an embodiment, the suspense mode controller is configured to make the display of the subsequent reel different by making the speed of spinning different.

### BRIEF DESCRIPTION OF SEVERAL VIEWS OF THE DRAWINGS

FIG. 1 is a perspective view of a stand alone gaming machine according to an embodiment;

FIG. 2 is a block diagram of the functional components of a gaming machine according to an embodiment;

FIG. 3 is a schematic diagram of the functional components of a memory according to an embodiment;

FIG. 4 is a schematic diagram of a network gaming system according to an embodiment;

FIG. 5 is an exemplary display during a game in accordance with an example of an embodiment;

FIG. 6 is a block diagram of the gaming system according to an embodiment; and

FIG. 7 is a flowchart showing the method of an embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Referring to the drawings, there is shown a gaming system arranged to implement a method of displaying an outcome of a game. A suspense mode where display of at least one subsequent reel is made different to at least the first reel is invoked in response to occurrence of a first suspense condition and the display of a later reel is made different if a second suspense condition is met. The gaming system can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

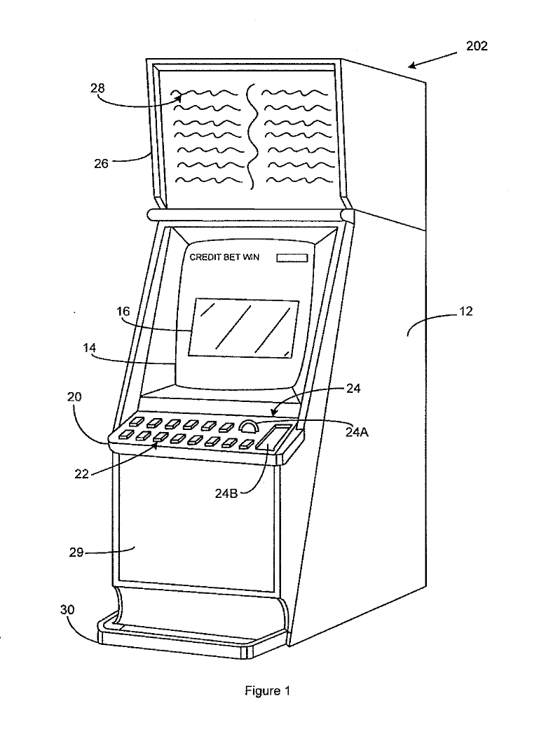

A gaming system in the form of a stand alone gaming machine 10 according to an embodiment is illustrated in FIG. 1. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during gameplay. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

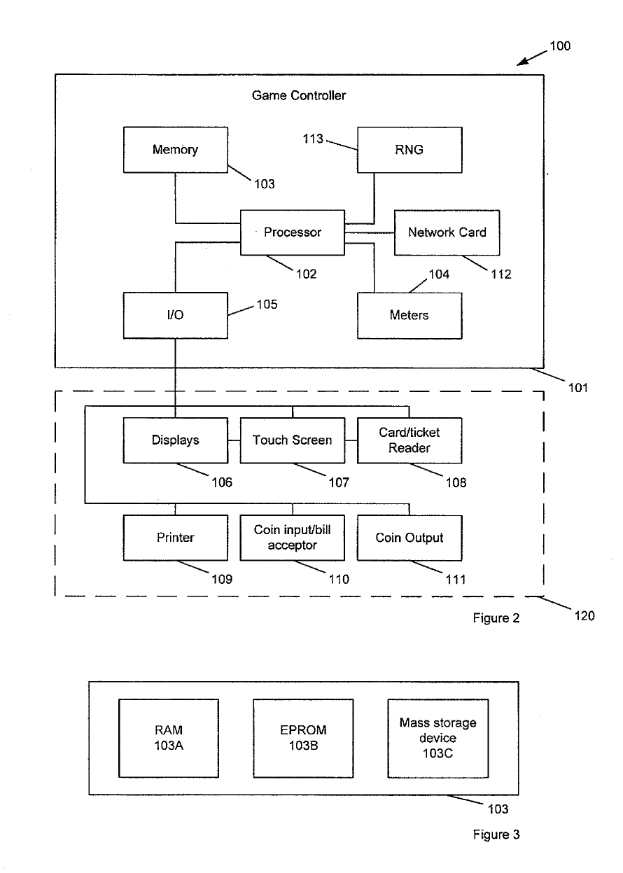

FIG. 2 shows a block diagram of operative components of a typical gaming machine which may be the same as or different to the gaming machine of FIG. 1 according to an embodiment.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 2, a player interface 120 includes peripheral devices that communicate with the game controller 101 comprise one or more displays 106, a touch screen 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

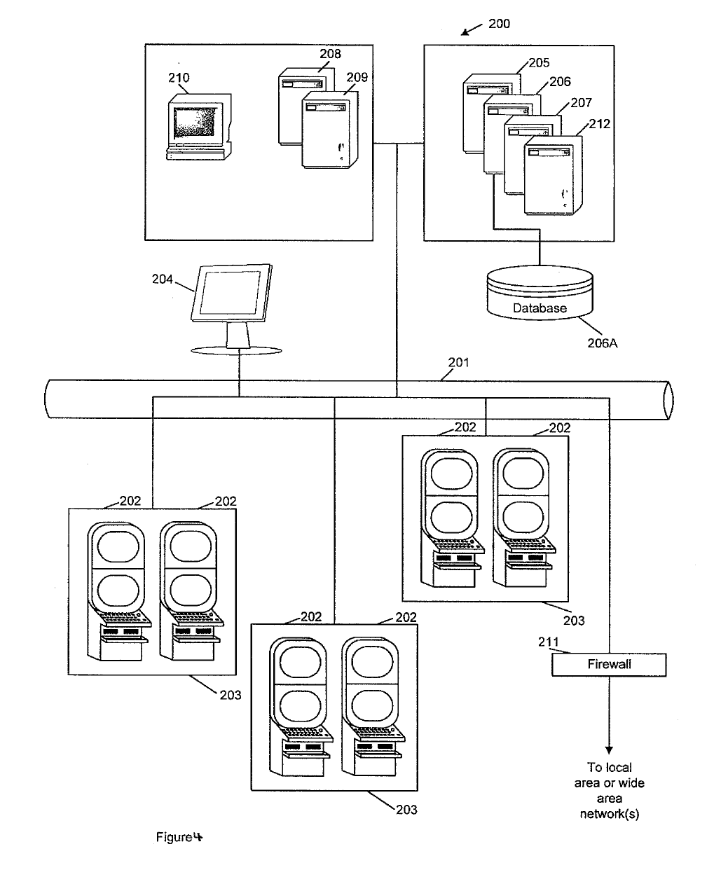

FIG. 3 shows a block diagram of the main components of an exemplary memory 103 according to an embodiment. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

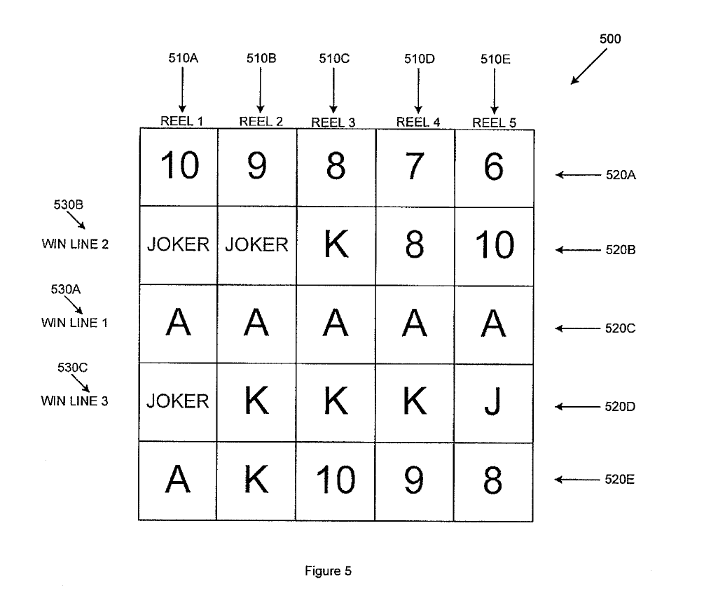

FIG. 4 shows a gaming system 200 in accordance with an embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 1 and 2, or may have simplified functionality depending on the requirements for implementing game play. While banks 203 of two gaming machines are illustrated in FIG. 4, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

In certain embodiments, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, in certain embodiments, a plurality of games servers may be provided to run different games or a single game server may run a plurality of different games as required by the terminals.

Gaming systems for implementing games that involve a display of spinning reels as part of the display of the outcome of a game have either a video display or a mechanical display, these later machines most usually being “stepper” machines which have a separate motor for each reel.

The game controllers of such gaming machines have a stop determining function that determines the stop position for each reel. For example, if there are five reels, each having twenty symbols, the stop determining function might determine that the stop positions are positions: 3, 13, 7, 9 and 17. The spinning of the reels is then controlled so that each symbol comes to a stop in the same row, typically a predetermined row in a “window” visible to the player on the display that which corresponds to a player playing a single win line. When a reel stops, the symbols will be in one of a plurality of possible symbol positions for that reel relative to the stop position.

Certain embodiments apply both to cases where the gaming system has a predetermined number (one or more) of win lines and where the gaming systems allow a player to select how many win lines of a plurality of win lines they will play in each game—i.e. a minimum of one win line up to the maximum number of win lines allowed by the game. Each win line is formed by a set of symbol positions consisting of one symbol position from each reel. That is, a predetermined symbol position of each reel is assigned to a win line. The symbol positions that constitute each of the win lines are usually advertised to the player by markings on the display or diagrams showing the symbol positions that correspond to each win line. Some of the win lines will be horizontal or diagonal lines but others may be non-linear combinations of symbols. Typically, the win lines will be constituted by symbol positions in the visible window.

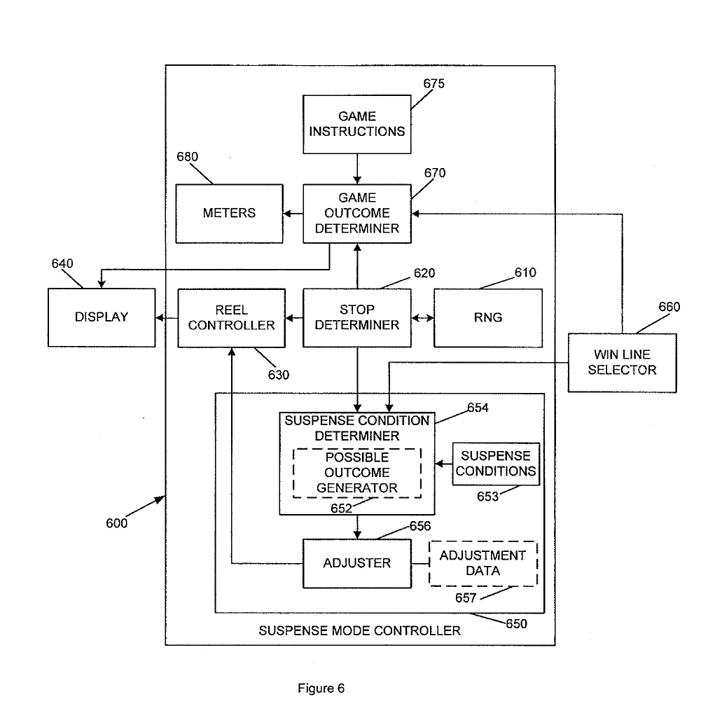

FIG. 6 shows the main functional components of a gaming system 600 of an embodiment. The game controller 605 includes a suspense mode controller 650 that controls whether the gaming system will enter a “suspense mode”, during which display of the spinning of at least one reel is controlled to be different to the spinning of another reel to thereby enhance game play. The suspense mode controller 650 determines which win lines the player has selected to play and then determines whether a suspense condition is met in relation to the one or more of player selected win lines. Depending on the nature of the suspense condition, it may be met in relation to a single win line or by a combination of win lines as described below. In certain embodiments, the suspense mode controller is configured to determine whether multiple suspense conditions are met and make multiple changes to display of multiple reels as described in further detail below.

In order to play the game, the player enters credits using a credit mechanism in a conventional manner. The player then operates the player interface to specify the amount they want to bet per win line and the number of win lines they wish to play by operating a win line selector 660. That is, the player may play one or a plurality of win lines up to the maximum number of win lines available for the game. For example if there are a maximum of three win lines, the player may play one, two or three win lines. A stop determiner 620, obtains random numbers from the random number generator 610 and uses them to determine the stop position of each of the reels. As described above, the stop positions will specify which symbols of each reel will correspond to win lines.

The stop positions are supplied by the stop determiner 620 to a reel controller 630 which controls the display of the spinning of individual reels to stop positions on display 640. In normal operation of a video display this will result in a display where the reel is animated so that initially the reel is imperceptible to give the impression of spinning and then the symbols become perceptible so that a certain number of symbols (for example 6 symbols) can be viewed by the player before the reel reaches the stop position. In a mechanical display, the reel needs to be moved from its current stop position (from the previous game) to the new stop position.

As described in further detail below the reel controller 630 may receive adjustment instructions from suspense mode controller 650 which is used by the reel controller 630 to control the display of spinning of the reels to make display of at least one reel different. The stops are also provided to a game outcome processor 670. The game outcome processor 670 processes the stop positions in accordance with the game rules 675 and the selected win lines to determine whether the player has won. The game outcome processor 670 alters meters 680 based on the game outcome and causes the prize outcome to be displayed on the display 640 once the reel controller 630 has caused the display 640 to display all reels spinning to a stop position.

The suspense mode controller 650 determines whether one or more adjustment instructions are to be supplied to the reel controller 630 during a game. The adjustment instruction causes the reel controller 630 to alter the display of spinning of at least one reel. In certain embodiments, the reel controller 630 applies the adjustment until it receives a subsequent adjustment instruction advising it to end suspense mode and return to normal display or to apply a further change to display of a later reel.

In order to facilitate understanding of which reel has had a display alteration applied to it, the following convention is employed. Any reel to which a first display change is made is referred to as a subsequent reel. This is in the sense that it is subsequent to spinning of at least the first reel and possibly other unmodified reels. A reel to which another change is applied is referred to as a later reel. Any reels between the unmodified reels and the later reel are referred to as intervening reels. It will be appreciated that in some embodiments each intervening reel will be a subsequent reel. That is, one or more reels may be displayed normally, then one or more subsequent reels displayed with a first difference and a later reel will follow on immediately from display of the subsequent reels with a different display, for example, first and second extended durations. However, it is also possible that there will be an intervening reel which is displayed normally after a subsequent reel. For example, in a five reel display a suspense mode may be turned on after first and second reels, turned off after a third reel and turned on again for the fifth reel. In this example, the third reel and second reels are intervening reels but only the second reel is a subsequent reel as it is the only one that is displayed differently to the normal display of the reel.

In certain embodiments, the adjustments will be cumulative. That is, a first difference in display will have been applied to the subsequent reel and a second difference is applied to the later reel in addition to that that has previously been applied. For example, if the duration of the reel has been extended it may be extended further. Alternatively, if the duration has been extended, the speed may be changed for a subsequent reel or the direction of spinning. A variety of different variations in the display may be made.

Further, if for example the first suspense condition indicates a very high likelihood of prize, but the second indicates a lesser prize, a greater change can be applied to a subsequent reel and a lesser change applied to the later reel. For example, in a case where a prize is awarded for five aces on a win line, the duration of the spin may be extended for a first time after two aces appear, a second time after three aces appear and a third time once four aces appear and it appears highly likely the player will win the prize corresponding to five aces.

A suspense mode will be ended if a suspense condition is no longer met and there are more reels to be spun.

In order to determine whether display of a reel should be different, the suspense condition determiner 654 processes the win lines that are selected by win line selector 660 in conjunction with the reel stop positions produced by the stop determiner 620, and reel data 651 that specifies the symbols that make up each reel to thereby determine the symbols that will appear on win lines that a player has selected.

This allows the suspense condition determiner 654 to determine whether a suspense condition will be met such as a predetermined game outcome appearing possible after a certain number of reels reach their stop positions. That is, whether the symbols that will appear on a win line correspond to the initial portion of a winning combination of symbols. If a suspense condition is satisfied, adjuster 656 determines an adjustment and supplies it to the reel controller 630. If in a specific embodiment only one type of adjustment is applied, the adjuster can send an adjustment instruction to the reel controller 630 which is configured to make the relevant adjustment, for example if suspense mode is switched on and off. Depending on the embodiment the adjuster 656 may calculate the adjustment based on a predetermined formula or obtain the relevant adjustment from adjustment data 657 and send it as an adjustment instruction specifying the adjustment to reel controller 630 for implementation.

In an embodiment, the suspense condition determiner 654 includes a possible outcome processor 652 which determine what game outcomes will appear possible after each reel has reached its stop position so these can be matched to current suspense conditions 653. This allows flexibility in implementation of the suspense mode controller as the suspense conditions can be changed. However, it may be more computationally efficient only to evaluate individual suspense conditions. For example, the suspense condition determiner 654 may run a specific sub routines to monitor for each suspense condition being monitored. For example, a sub-routine to count a number of symbols.

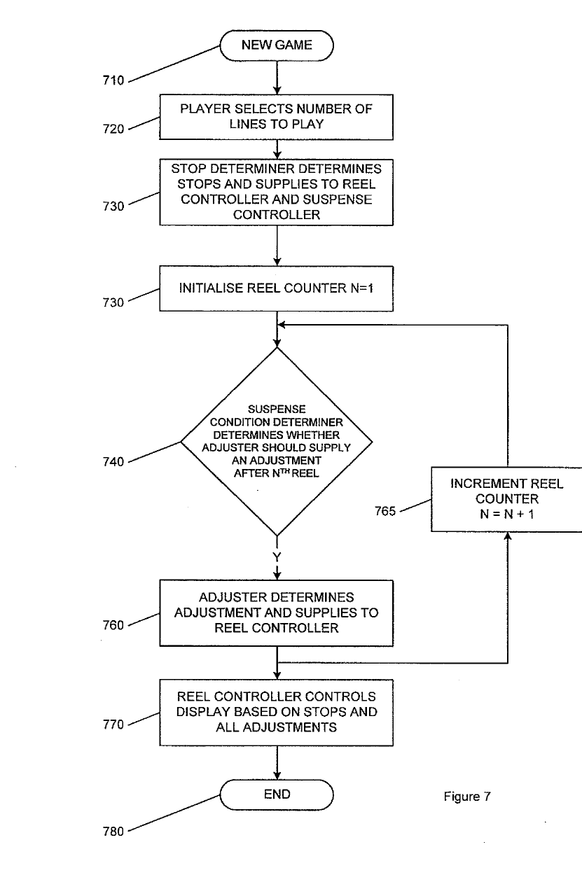

Referring to the flow chart in FIG. 7 of an embodiment, at step 710 a new game is started. At step 720 a player operates the win line selector to select a number of lines to play. At step 730 the stop determiner determines the stops and supplies data specifying these to the reel controller 630 and the suspense condition determiner 654. A counter is initialised at step 735 with the number of reels after which the suspense condition is to be determined (in this case one). At step 740 the suspense conditioner determines whether the adjuster should generate adjustment data after the current reel has spun to a stop. If a suspense condition is met, at step 760 the adjuster determines an adjustment and supplies it to the reel controller as adjustment data. The reel counter is incremented at step 765 and the process 740,760 repeated for each reel except the last reel. At step 770 the reel controller controls displays of spinning of each reel to the stop position based on the stops and adjustments. At step 780 the game ends. In certain embodiments, one or more or all reels may be processed prior to the any reels being displayed.

In certain embodiments, the normal duration or speed of spinning may include some variation, for example within a normal range, and changes to the display should be understood in this context.

Suspense Conditions

A suspense condition may be based on a predetermined game outcome being possible after one or more reels are spun to a stop position. The game outcome may be an entry in a pay table for the game or may be a value derived from the pay table such as a prize threshold. The number of reels that are required to have reached the stop position may form part of the suspense condition. For example, one suspense condition may be invoked in relation to a “wild” symbol that can be substituted for any other symbol. In this case even after a first reel is spun to a stop position, if a wild symbol corresponds to a win line, at that point in the game, it will appear to the player that they have a higher likelihood of winning a prize and accordingly it may be appropriate to determine that a suspense condition has been met. In contrast, if a prize is awarded for five symbols of the same type, it may be appropriate to trigger a suspense condition after two or three symbols of the same type have been spun to a stop on the same win line.

A suspense condition may be based on the predetermined game outcome being that a prize is above a particular threshold value. For example, the suspense condition determiner 654 may determine a number of possible game outcomes in the pay table appear possible after three of the reels have spun to a stop and based on the associated prizes determines whether any of the prizes are above a preset threshold.

A suspense condition may be based on a combination of two or more factors, for example the size of the prize corresponding to the outcome that appears possible and how likely it appears after a reel has spun to a stop that the player will win the prize; that is, based on the probability of the outcome occurring.

By way of specific example, in one game a prize may be awarded for five aces and may be the maximum prize for that game. A lesser prize may be awarded for four aces. A suspense condition may be set in relation to the five ace prize, so that if the first three reels each have aces on a win line, a suspense mode may be triggered. That is, the five ace prize appears to be possible after three reels and is judged to be sufficiently likely once the first three reels have aces. If the first three reels are two aces and a king, suspense mode is not entered into and suspense mode will only be entered into if three of the first four reels are aces because it is not until the fourth reel that it is deemed that it will appear sufficiently likely that they will win the four ace prize and hence it is deemed appropriate to enter the suspense mode in view of the size of the prize. In this example, for a higher prize a relatively lower likelihood is sufficient to trigger a suspense mode.

The above suspense conditions relate to a symbol combination on a single win line, however the suspense condition may based on multiple win lines. For example, in one embodiment a suspense mode may only be entered into if a game outcome from the pay table appears possible in relation to two or more win lines played by a player. That is, a subset of all winning outcomes specified in the pay table may be sufficient to initiate a suspense mode if two or more such winning outcomes appear possible for different win lines.

Alternatively, it may be required that the total of the win outcomes that appear possible across all win lines played by the player exceed a prize threshold such that possible outcomes from separate wins can contribute to that total. That is, apparent game outcomes with prizes below the threshold on an individual win line will not trigger a suspense mode but if the total of prizes that appear possible after a certain number of reels exceeds the threshold the suspense mode may be entered into. Different thresholds may be set for different numbers of reels having spun to a stop and/or different numbers of win lines.

Adjustments

The display may be adjusted by altering the duration of the spinning of one or more reels. For example, if two aces appear on the first reel and second reels, the duration of spinning of the third reel may be extended.

Alternatively, the speed of spinning or a reel may be adjusted. For example, if aces appear on the first four reels, the duration of the spinning of the fifth reel may be the same but the speed of the spinning of the fifth reel may be slowed so that the player can more readily perceive the symbols on the reel as they move into position or sped up as an indicator of excitement.

Another possible adjustment of the display is to reverse the direction of spinning of the reel.

It is possible to combine variations of spinning. For example, in an example where a winning outcome appears possible on multiple reels, if a winning outcome appears possible on one reel, the duration may be altered but if it appears possible on two win lines, both duration and speed may be altered.

The adjuster 656 may determine a size of an adjustment dependent on:

a) the size of the prize;

b) the number of reels in relation to which a suspense condition is met;

c) a number of suspense conditions that are met; or

d) the likelihood of a prize outcome.

### EXAMPLE

Referring to FIG. 5 there is shown an exemplary display 500 that may occur during a game according to an embodiment. In the gaming machine of FIG. 5 five lines of symbols 520A to 520E are displayed on the display once all reels have spun to a stop. There are five reels 510A to 510E. While five lines are displayed, only three lines 530A, 530B and 530C are win lines. If the player selects to play one win line, they play win line one 530A. Win line two 530B is also played if they select two win lines and win line three is added 530C if they select three win lines.

Consider an example where a player selects to play two win lines. In the example given, assume that a suspense mode is initiated if a player stands a chance of obtaining five symbols of the same kind on any win line the player is playing. The machine may enter single, double or triple suspense mode depending on the number of win lines in relation to which a suspense condition is met. Accordingly in single suspense mode duration is doubled, in double suspense mode, duration is tripled and in triple suspense mode duration is quadrupled. As the player is only playing two win lines, the player can only reach double suspense mode. Assume that reels one to five 510A to 510E are spun to a stop in numerical order. The order of the reels displayed may be varied depending on the embodiment. Once reel one has spun to a stop, single suspense mode is activated because the player has a Joker on win line 2 and a Joker acts as a wild symbol which may be substituted for any of the other symbols. Thus irrespective of the symbol that appears on win line two on reel two, the player will have an increased apparent chance of winning. Accordingly single suspense mode is entered into after a first reel is spun to a stop position. When the second reel spins to a stop position, it is now apparent that there are aces on reels one and two corresponding to win line one. Accordingly, at this stage double suspense mode is entered into because it appears that the player can obtain a win on two suspense lines. Double suspense mode continues after reel three spins to a stop position because it still appears possible for the players to obtain five aces and five kings. When reel four spins to a stop, a suspense condition is no longer met in relation to win line two because a player can no longer obtain five of the same symbols on win line two. Accordingly the machine reverts to single suspense mode. Single suspense mode is maintained until the last reel spins to a stop position.

Various modifications will be apparent to persons skilled in the art, and should be understood as falling within the scope of the appended claims.

For the purposes of this specification it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Australia or any other country.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of displaying an outcome of a game to a player comprising:
obtaining a stop position for each of a plurality of reels, each reel having a plurality of symbols, each stop position specifying which symbol or symbols of each reel will correspond to a win line;
displaying spinning of each reel to the reel's stop position with at least the first reel being spun normally to the first reel's stop position;
making the display of the spinning of at least one subsequent reel different to the normal spinning if it is determined that at least one first suspense condition is met; and
making the display of at least one later reel different to at least one intervening reel displayed as spun to a stop after the first reel, if at least one second suspense condition is met.

2. A method as claimed in claim 1, wherein each at least one intervening reel is a subsequent reel, and making the display of the at least one later reel different comprises making the duration of each later reel different to the normal duration of spinning and the duration of the subsequent reel such that there are three different durations.

3. A method as claimed in claim 1, wherein each at least one intervening reel is a reel displayed as spun to a stop after each at least one subsequent reel.

4. A method as claimed in claim 3, wherein each at least one later reel is spun for the same duration as each at least one subsequent reel.

5. A method as claimed in claim 1, wherein the normal duration comprises a normal range of durations.

6. A method as claimed in claim 1, wherein determining whether a suspense condition is met comprises determining whether at least one game outcome that satisfies a suspense condition will appear possible prior to a reel being displayed spinning to the reel's stop position.

7. A method as claimed in claim 1, wherein making the duration of the at least one subsequent reel different comprises making the duration longer than the normal duration.

8. A method as claimed in claim 1, wherein making the display of the later reel different comprises making the speed of spinning different.

9. A method as claimed in claim 1, further comprising making the speed of the at least one subsequent reel different to the first reel.

10. A gaming system comprising:
a stop determiner configured to determine a stop position of a each of a plurality of reels, each reel having a plurality of symbols, each stop position specifying which symbol or symbols of the reel will correspond to a win line;
a display for displaying spinning of each reel to the reel's stop position with at least a first reel being spun normally to the first reel's stop position; and
a suspense mode controller configured to determine whether one or more suspense conditions are met and make display of the spinning of at least one subsequent reel different to the normal spinning if it is determined that a first suspense condition is met, and make the display of at least one later reel different to at least one intervening reel displayed as spun to a stop after the first reel if a suspense condition is met.

11. A gaming system as claimed in claim 10, wherein each at least one intervening reel is a subsequent reel, and the game controller is configured to make the display of the at least one later reel different by making the duration of each later reel different to the normal duration of spinning and the duration of the subsequent reel such that there are three different durations.

12. A gaming system as claimed in claim 10, wherein each at least one intervening reel is a reel displayed as spun to a stop after each at least one subsequent reel.

13. A gaming system as claimed in claim 12, wherein each at least one later reel is spun for the same duration as each at least one subsequent reel.

14. A gaming system as claimed in claim 10, wherein the normal duration comprises a normal range of durations.

15. A gaming system as claimed in claim 10, wherein the game controller determines whether a suspense condition is met comprises determining whether at least one game outcome that satisfies a suspense condition will appear possible prior to a reel being displayed spinning to the reel's stop position.

16. A gaming system as claimed in claim 10, wherein display of the at least one subsequent reel is made different by making the duration longer than a normal duration.

17. A gaming system as claimed in claim 10, wherein display of the later reel is made different by making the speed of spinning different.

18. A gaming system as claimed in claim 11, wherein display of the subsequent reel is made different by making the speed of the at least one subsequent reel different to the first reel.

19. A suspense mode controller for a gaming system, the suspense mode controller configured to:
obtain a stop position of a each of a plurality of reels, each reel having a plurality of symbols, each stop position specifying which symbols of the reel will correspond to respective ones of a plurality of win lines,
determine whether a suspense condition is met in respect of at least one win line played by the player;
make the display of the spinning of at least one subsequent reel different to the normal spinning if it is determined that at least one first suspense condition is met; and
make the display of at least one later reel different to at least one intervening reel displayed as spun to a stop after the first reel, if at least one second suspense condition is met.

20. A suspense mode controller as claimed in claim 19, wherein each at least one intervening reel is a subsequent reel, and the suspense mode controller is configured to make the display of the at least one later reel different by making the duration of each later reel different to the normal duration of spinning and the duration of the subsequent reel such that there are three different durations.

21. A suspense mode controller as claimed in claim 19, wherein each at least one intervening reel is a reel displayed as spun to a stop after each at least one subsequent reel.

22. A suspense mode controller as claimed in claim 21, wherein each at least one later reel is spun for the same duration as each at least one subsequent reel.

23. A suspense mode controller as claimed in claim 19, wherein the normal duration comprises a normal range of durations.

24. A suspense mode controller as claimed in claim 19, the suspense mode controller determines whether a suspense condition is met by determining whether at least one game outcome that satisfies a suspense condition will appear possible prior to a reel being displayed spinning to the reel's stop position.

25. A suspense mode controller as claimed in claim 19, wherein the suspense mode controller is configured to make the duration of the at least one subsequent reel different by making the duration longer than the normal duration.

26. A suspense mode controller as claimed in claim 19, wherein the suspense mode controller is configured to make the display of the later reel different by making the speed of spinning different.

27. A suspense mode controller as claimed in claim 20, wherein the suspense mode controller is configured to make the display of the subsequent reel different by making the speed of spinning different.
